(19) United States
(12) Patent Application Publication
(10) Pub. No.: US 2004/0085706 A1
(43) Pub. Date: May 6, 2004

(54) Electrostatic chuck, supporting table and plasma processing system

(76) Inventor: Riki Tomoyoshi, Nirasaki-Shi (JP)

Correspondence Address: SMITH, GAMBRELL & RUSSELL, LLP, 1850 M STREET, N.W., SUITE 800, WASHINGTON, DC, 20036, US

(21) Appl. No.: 10/453,929

(22) Filed: Jun. 4, 2003

(30) Foreign Application Priority Data
Jun. 6, 2002 (JP) 2002-165377

(51) Int. Cl. H02H 1/00

(52) U.S. Cl. 361/234

(57) ABSTRACT

A plasma processing system comprises: a processing vessel; a supporting table, provided in the processing vessel, for supporting thereon the object; a gas supply system for supplying a process gas into the processing vessel; and an electromagnetic supply system for generating the plasma of the process gas. The supporting table includes a susceptor provided in the processing vessel, and an electrostatic chuck provided on the susceptor. The electrostatic chuck has a porous dielectric member and a porous conductive member provided within the dielectric member, so that a heat transfer gas can uniformly pass therethrough. In place of the porous conductive member, a conductive member having a large number of through holes may be used. Between the susceptor and the electrostatic chuck, a gas buffer communicated with a heat transfer gas feeding passage is formed.

### BACKGROUND OF THE INVENTION

1. Field of the Invention

The present invention relates to an electrostatic chuck for attracting and holding, e.g. an object to be processed. The present invention also relates to a supporting table having such an electrostatic chuck for supporting the object, and a plasma processing system having such a supporting table.

2. Description of Related Art

In general, a plasma processing system, such as a plasma etching system, has a processing vessel, and a supporting table provided in the processing vessel. The supporting table is designed to attract and hold an object to be processed, e.g. a semiconductor wafer, on an electrostatic chuck provided in an upper portion thereof. In the processing vessel, a film formed on the semiconductor wafer on the supporting table is etched by utilizing plasma.

In this case, in order to cool the semiconductor wafer, the supporting table is cooled by a circulating refrigerant, and a heat transfer gas (e.g. He) is supplied between the bottom of the semiconductor wafer and the electrostatic chuck. Specifically, as shown in FIG. 2, a gas buffer 103 is formed in a susceptor 102 of a supporting table 101. There is also provided a plurality of gas supply pipes 105 extending from the gas buffer 103 to the top face of the electrostatic chuck 104 via the susceptor 102. Reference numbers 106 and 107 denote a heat transfer gas feeding passage to the gas buffer 103, and a refrigerant circulating passage formed in the susceptor 102, respectively.

However, if the heat transfer gas is fed via the gas pipes, the heat transfer gas does not always uniformly pass through the electrostatic shuck. For that reason, the temperature of the semiconductor wafer is not always uniform. The gas pipes passing through the electrostatic chuck are substantially straight, so that the gas passage route from the susceptor to the bottom of the semiconductor wafer is short. For that reason, there is some possibility that an abnormal discharge occurs in the gas pipes by a potential difference caused between the susceptor and the bottom of the semiconductor wafer. If the abnormal discharge occurs in the gas pipes, there is a problem in that the gas pipes may corrode and/or the bottom of the semiconductor wafer may be damaged.

### SUMMARY OF THE INVENTION

The present invention has been made in view of such circumstances, and it is an objective of the present invention to provide an electrostatic chuck capable of allowing a heat transfer gas to uniformly pass therethrough.

In order to accomplish the aforementioned objective, the present invention provides an electrostatic chuck comprising: a porous dielectric member; and a porous conductive member provided within the dielectric member. Thus, since the conductive member within the dielectric member, as well as the dielectric member, is porous, the heat transfer gas can uniform pass through the electrostatic chuck.

The present invention also provides an electrostatic chuck comprising: a porous dielectric member; and a conductive member provided within the dielectric member and having a large number of, through holes. Thus, even if the conductive member within the dielectric member is non-porous, if the conductive member has a large number of through holes like a mesh, the heat transfer gas can uniformly pass therethrough like a porous material.

It is another objective of the present invention to provide a supporting table having such an electrostatic chuck, the supporting table being capable of enhancing the uniformity of temperature of an object to be processed.

In order to accomplish the aforementioned objective, the present invention provides a supporting table for supporting thereon an object to be processed in a processing vessel, the supporting table comprising: a susceptor provided in the processing vessel; an electrostatic chuck provided on the susceptor, the electrostatic chuck having a porous dielectric member and a porous conductive member provided within the dielectric member; and a heat transfer gas feeding passage communicated with the electrostatic chuck.

The present invention also provides a supporting table for supporting thereon an object to be processed in a processing vessel, the supporting table comprising: a susceptor provided in the processing vessel; an electrostatic chuck provided on the susceptor, the electrostatic chuck having a porous dielectric member and a conductive member, the conductive member being provided within the dielectric member and having a large number of through holes; and a heat transfer gas feeding passage communicated with the electrostatic chuck.

By using these supporting tables, the heat transfer gas can uniformly pass through the electrostatic chuck, so that the temperature of the object can be uniformly controlled.

Although the gas feeding passage can be directly connected to the electrostatic chuck, these supporting tables preferably further comprise a gas buffer formed between the susceptor and the electrostatic chuck, the gas buffer being communicated with the gas feeding passage. Thus, the heat transfer gas can more uniformly pass through the electrostatic chuck. The heat transfer gas in the buffer is inversing between the susceptor and the electrostatic chuck, so that the heat transfer from the susceptor to the electrostatic chuck increases. Therefore, the temperature control, such as heating and cooling, of the object can be efficiently carried out.

It is a further objective of the present invention to provide a plasma processing system having such a supporting table in a processing vessel so that it is difficult to cause an abnormal discharge between a susceptor and an object to be processed by feeding gases.

In order to accomplish the aforementioned objective, the present invention provides a system for processing an object with a plasma, the system comprising: a processing vessel; a supporting table, provided in the processing vessel, for supporting thereon the object; a gas supply system for supplying a process gas into the processing vessel; and an electromagnetic supply system for generating the plasma of the process gas in the processing vessel, the supporting table including: a susceptor provided in the processing vessel; an electrostatic chuck provided on the susceptor, the electrostatic chuck having a porous dielectric member and a porous conductive member provided within the dielectric member; a gas buffer formed between the susceptor and the electrostatic chuck; and a heat transfer gas feeding passage communicated with the gas buffer.

The present invention also provides a system for processing an object with a plasma, the system comprising: a processing vessel; a supporting table, provided in the processing vessel, for supporting thereon the object; a gas supply system for supplying a process gas into the processing vessel; and an electromagnetic supply system for generating the plasma of the process gas in the processing vessel, the supporting table including: a susceptor provided in the processing vessel; an electrostatic chuck provided on the susceptor, the electrostatic chuck having a porous dielectric member and a conductive member, the conductive member being provided within the dielectric member and having a large number of through holes; a gas buffer formed between the susceptor and the electrostatic chuck; and a heat transfer gas feeding passage communicated with the gas buffer.

According to these plasma processing systems, the heat transfer gas passes through the pores of the porous dielectric member, and the pores of the porous conductive member or the through holes of the conductive member in the electrostatic chuck. Therefore, the passage route of the heat transfer gas is complicated and long. Thus, even if there is a potential difference between the object and the susceptor, it is possible to prevent abnormal discharge in the passage route of the heat transfer gas. Thus, it is possible to prevent the object from being damaged by abnormal discharge.

In these plasma processing systems, a heat exchange medium circulating passage is preferably formed in the susceptor of the supporting table. Thus, the temperature of the electrostatic chuck can approach to the temperature of the cooled or heated susceptor by means of the heat transfer gas in the gas buffer.

In the above described supporting tables or plasma processing systems, it is not always required to mount the electrostatic chuck directly on the susceptor. That is, the supporting table may further include an intermediate member provided between the electrostatic chuck and the susceptor. Thus, even if there is a difference in coefficient of thermal expansion between the dielectric member of the electrostatic chuck and the susceptor, it is possible to suppress thermal stress caused between the electrostatic chuck and the susceptor by making the intermediate member of a material having an intermediate coefficient of thermal expansion therebetween. A plurality of such intermediate members may be provided.

As described above, according to the present invention, the electrostatic chuck has such a structure that the porous conductive member or the conductive member having the large number of through holes is provided in the porous dielectric member. Thus, the whole electrostatic chuck can have a gas permeable structure, so that the heat transfer gas can uniformly pass therethrough. Therefore, it is possible to more uniformly control the temperature of the object on the supporting table, and it is possible to prevent abnormal discharge on the bottom of the object.

### BRIEF DESCRIPTION OF THE DRAWINGS

FIG. 1 is a schematic sectional view showing a preferred embodiment of a plasma processing system according to the present invention; and

FIG. 2 is a schematic sectional view showing a part of a conventional plasma processing system.

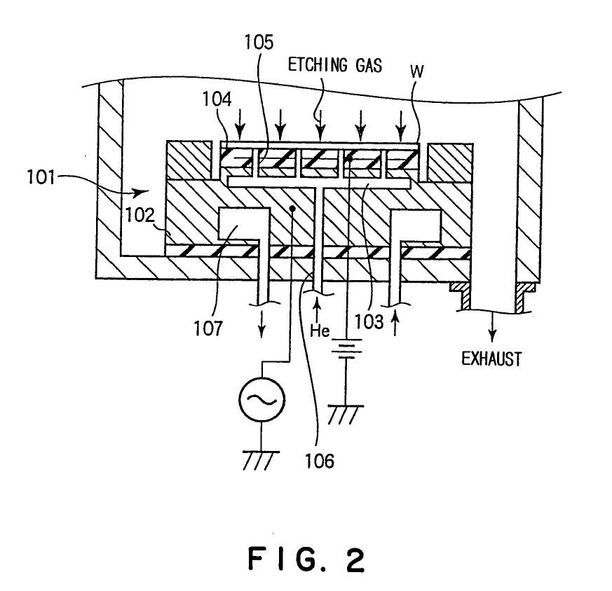

### DESCRIPTION OF THE PREFERRED EMBODIMENT

Referring to the accompanying drawings, a preferred embodiment of the present invention will be described below.

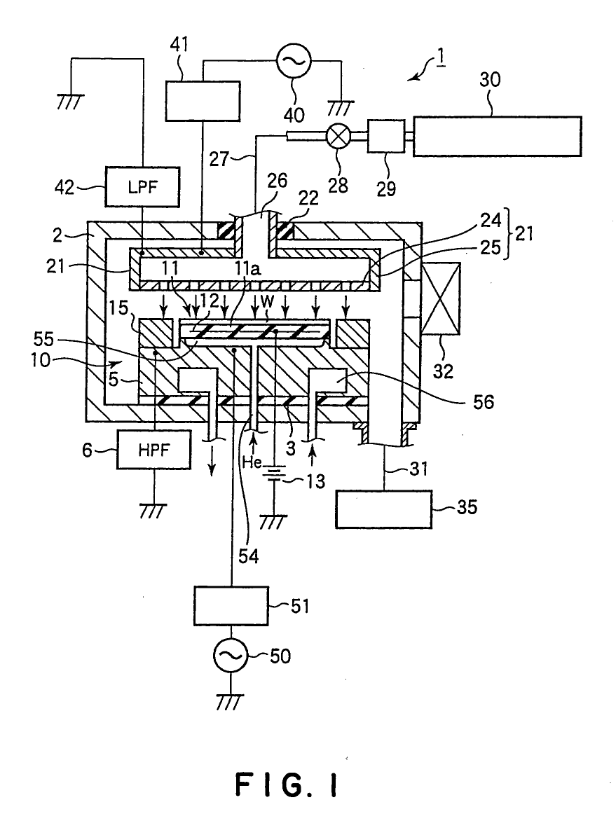

FIG. 1 is a sectional view showing a plasma etching system 1 by which the present invention is embodied. A processing vessel 2 is formed of a metal, e.g. aluminum, the surface of which is oxidized, and is grounded for safety. On the inner bottom of the processing vessel 2, a susceptor 5 serving as a bottom electrode of a pair of parallel plate electrodes is mounted via an insulator 3. A high pass filter (HPF) 6 is connected to the susceptor 5. On the susceptor 5, a substantially disk-shaped electrostatic chuck 11 on which an object W to be processed, such as a semiconductor wafer is mounted, is provided.

The electrostatic chuck 11 has a porous dielectric member 11a, and a porous dielectric member 12 provided therein. The electrostatic chuck 11 can be produced by sandwiching a porous conductive thin film between two porous dielectric plates and burning them to integrate with each other. The burning is carried out at a temperature at which the dielectric member and conductive members do not completely sinter. Because the dielectric member and conductive members are dense to lose gas permeable pores if the burning temperature is too high. The conductive member 12 is not limited to the porous conductive member, and it may be a conductive member having a large number of through holes, e.g. a metal mesh or a punching metal. The conductive member 12 is connected to a DC power supply 13. If a DC voltage is applied to the conductive member 12 from the DC power supply 13, the object W is attracted and held onto the top face of the dielectric member 11a by electrostatic force (Coulomb force).

The electrostatic chuck 11 is bonded to the top face of the susceptor 5 by an adhesive. The electrostatic chuck 11 may be simply put on the susceptor 5, or fixed thereto by a method other than adhesion (e.g. bolting). It is not always required to mount the electrostatic chuck 11 directly on the susceptor 5. That is, the supporting table 10 may have at least one intermediate member provided between the electrostatic chuck 11 and the susceptor 5. Thus, even if there is a difference in coefficient of thermal expansion between the dielectric member 11a of the electrostatic chuck 11 and the susceptor 5, it is possible to suppress thermal stress caused between the electrostatic chuck 11 and the susceptor 5 by making the intermediate member of a material having an intermediate coefficient of thermal expansion therebetween.

A gas buffer 55 is provided between the electrostatic chuck 11 and the susceptor 5 by forming a disk-shaped recessed portion in the top face of the susceptor 5. The gas buffer 55 is communicated with a heat transfer gas feeding passage 54 passing through the susceptor 5. The gas buffer 55 is designed to temporarily store a heat transfer gas, such as He gas, fed from the feeding passage 54. The heat transfer gas temporarily stored in the buffer 55 passes through the porous dielectric member 11a and porous conductive member 12, which are forming the electrostatic chuck 11, to reach the bottom of the object W. Thus, the heat transfer gas is filled between the electrostatic chuck 11 and the object W, so that the temperature of the object W can approach to the temperature of the electrostatic chuck 11 even at a reduced pressure.

Since the whole electrostatic chuck 11 is porous, the heat transfer gas can uniformly pass therethrough. In the porous material, the gas permeable region (the volume of pores) is small, and the passage route of the heat transfer gas is complicated and long. For that reason, even if there is a potential difference between the object W and the susceptor 5, it is possible to suppress abnormal discharge on the bottom of the object W. Since the heat transfer gas in the gas buffer 55 is inversing between the susceptor 5 and the electrostatic chuck 11, the temperature of the electrostatic chuck 11 can approach to the temperature of the cooled susceptor even at a reduced pressure.

As described above, the supporting table 10 in this preferred embodiment comprises the susceptor 5, the electrostatic chuck 11, the gas buffer 55 and the heat transfer gas feeding passage 54.

In the susceptor 5, a refrigerant circulating passage 56 for circulating a refrigerant to cool the body of the susceptor. The refrigerants include cold water, liquid nitrogen, alcohols and so forth. Of course, if the object is intended to be processed at a high temperature, a high temperature medium, such as hot water or a high temperature oil, can be circulated in place of the refrigerant.

On the susceptor 5, a focus ring 15 is arranged so as to surround the object W. The focus ring 15 is made of Si or the like for improving the uniformity of etching by means of plasma.

Above the supporting table 10, a shower head 21 serving as a top electrode is provided so as to face the susceptor 5. The shower head 21 is supported on the top portion of the processing vessel 2 via an insulator 22. The shower head 21 comprises an electrode plate 24 having a large number of gas holes, and a supporting body 25 for supporting thereon the electrode plate 24.

In the center of the top portion of the supporting body 25, a gas inlet 26 is provided. To the gas inlet 26, a gas supply pipe 27, a valve 28, a mass flow controller 29 and an etching gas supply source 30 are sequentially connected. From the etching gas supply source 30, an etching gas, such as CF₄ gas, is supplied.

An exhaust pipe 31 is connected to the bottom portion of the processing vessel 2. The exhaust pipe 31 is connected to an exhaust system 35. On the side wall of the processing vessel 2, a gate valve 32 is provided. Via the gate valve 32, the object W is carried between the processing vessel 2 and a load-lock chamber (not shown) adjacent to the processing vessel 2.

A low pass filter (LPF) 42 is connected to the shower head 21 serving as a top electrode. In addition, a first high frequency power supply 40 is connected to the shower head 21 via a matching device 41. A second high frequency power supply 50 is connected to the susceptor 5 serving as a bottom electrode, via a matching device 51. Thus, an electromagnetic supply system for generating a high frequency electric field between the top electrode 21 and the bottom electrode 5 is formed to generate plasma of an etching gas.

A process for plasma-etching a film formed on the object W to be processed by means of the plasma etching system 1 with the above described construction will be described below.

First, the gate valve 32 is opened, and the object W is carried in the processing vessel 2 to be mounted on the electrostatic chuck 11 of the supporting table 10. Then, the gate valve 32 is closed, and the pressure in the processing vessel 2 is reduced by means of the exhaust system 35. Then, a DC voltage is applied from the DC power supply 13 to the conductive member 12 in the electrostatic chuck 11.

Thereafter, the above described etching gases, e.g. CF₄, O₂ and Ar gases, are fed into the processing vessel 2 from the etching gas supply source 30. In this state, a high frequency power having a predetermined frequency is applied to the top electrode 21 from the first high frequency power supply 40. Thus, a high frequency electric field is formed between the top electrode 21 and the bottom electrode 5 to generate plasma of the etching gases. With the generation of plasma, the object W is electrostatically attracted and held onto the electrostatic chuck 11.

By the plasma of etching gases thus generated, the film formed on the object W is etched. At this time, a high frequency power having a predetermined frequency is applied from the high frequency power supply 50 to the susceptor 5 serving as the bottom electrode, so that ions in the plasma are drawn to the susceptor 5.

When etching is thus carried out, a heat transfer gas, e.g. He gas, is supplied to the gas buffer 55 from the heat transfer gas feeding passage 54. The heat transfer gas passes through the electrostatic chuck 11 to reach the bottom of the object W.

In this case, since the whole electrostatic chuck 11 is porous as described above, the heat transfer gas can uniformly pass therethrough. In the porous material, the gas permeable region (the volume of pores) is small, and the passage route of the heat transfer gas is complicated and long. For that reason, even if there is a potential difference between the object W and the susceptor 5, it is possible to suppress abnormal discharge on the bottom of the object W. Since the heat transfer gas in the gas buffer 55 is inversing between the susceptor 5 and the electrostatic chuck 11, the temperature of the electrostatic chuck 11 can approach to the temperature of the cooled susceptor even at a reduced pressure.

While etching is thus carried out, the emission intensity of plasma is monitored by an end point detector (not shown). When the end point detector detects a predetermined emission intensity, etching is finished.

While the susceptor has been formed with the gas buffer in the above described preferred embodiment, the present invention should not be limited thereto. For example, when the susceptor and the electrostatic chuck are aligned with each other via an O-ring to bolt them outside of the O-ring, the space formed inside the O-ring may be a gas buffer. In this case, it is not required to work the susceptor to form the gas buffer, costs can be decreased.

While the parallel plate type plasma processing system has been described in this preferred embodiment, the present invention should not be limited thereto. For example, the present invention may be applied to an inductively coupled plasma processing system using a plasma generating antenna, or a microwave-excited plasma processing system. The invention may also be applied to a system wherein a plasma-generating high frequency power is applied to a susceptor, a system wherein a biasing high frequency power is applied to a susceptor, and a system wherein a susceptor is grounded. The kind of the plasma-processing should not be limited to etching, but the present invention may be applied to a system for carrying out another kind of plasma-processing, such as deposition.

What is claimed is:

1. An electrostatic chuck comprising:
a porous dielectric member; and
a porous conductive member provided within said dielectric member.

2. An electrostatic chuck comprising:
a porous dielectric member; and
a conductive member provided within said dielectric member and having a large number of through holes.

3. A supporting table for supporting thereon an object to be processed in a processing vessel, said supporting table comprising:
a susceptor provided in said processing vessel;
an electrostatic chuck provided on said susceptor, said electrostatic chuck having a porous dielectric member and a porous conductive member provided within said dielectric member; and
a heat transfer gas feeding passage communicated with said electrostatic chuck.

4. A supporting table as set forth in claim 3, further comprising a gas buffer formed between said susceptor and said electrostatic chuck, said gas buffer being communicated with said gas feeding passage.

5. A supporting table as set forth in claim 3, further comprising an intermediate member provided between said electrostatic chuck and said susceptor.

6. A supporting table for supporting thereon an object to be processed in a processing vessel, said supporting table comprising:
a susceptor provided in said processing vessel;
an electrostatic chuck provided on said susceptor, said electrostatic chuck having a porous dielectric member and a conductive member, said conductive member being provided within said dielectric member and having a large number of through holes; and
a heat transfer gas feeding passage communicated with said electrostatic chuck.

7. A supporting table as set forth in claim 6, further comprising a gas buffer formed between said susceptor and said electrostatic chuck, said gas buffer being communicated with said gas feeding passage.

8. A supporting table as set forth in claim 6, further comprising an intermediate member provided between said electrostatic chuck and said susceptor.

9. A system for processing an object with a plasma, said system comprising:
a processing vessel;
a supporting table, provided in said processing vessel, for supporting thereon said object;
a gas supply system for supplying a process gas into said processing vessel; and
an electromagnetic supply system for generating said plasma of said process gas in said processing vessel,
said supporting table including:
a susceptor provided in said processing vessel;
an electrostatic chuck provided on said susceptor, said electrostatic chuck having a porous dielectric member and a porous conductive member provided within said dielectric member;
a gas buffer formed between said susceptor and said electrostatic chuck; and
a heat transfer gas feeding passage communicated with said gas buffer.

10. A plasma processing system as set forth in claim 9, wherein a heat exchange medium circulating passage is formed in said susceptor of said supporting table.

11. A plasma processing system as set forth in claim 9, wherein said supporting table further includes an intermediate member provided between said electrostatic chuck and said susceptor.

12. A system for processing an object with a plasma, said system comprising:
a processing vessel;
a supporting table, provided in said processing vessel, for supporting thereon said object;
a gas supply system for supplying a process gas into said processing vessel; and
an electromagnetic supply system for generating said plasma of said process gas in said processing vessel,
said supporting table including:
a susceptor provided in said processing vessel;
an electrostatic chuck provided on said susceptor, said electrostatic chuck having a porous dielectric member and a conductive member, said conductive member being provided within said dielectric member and having a large number of through holes;
a gas buffer formed between said susceptor and said electrostatic chuck; and
a heat transfer gas feeding passage communicated with said gas buffer.

13. A plasma processing system as set forth in claim 12, wherein a heat exchange medium circulating passage is formed in said susceptor of said supporting table.

14. A plasma processing system as set forth in claim 12, wherein said supporting table further includes an intermediate member provided between said electrostatic chuck and said susceptor.
